(19) United States
(12) Patent Application Publication
(10) Pub. No.: US 2004/0229026 A1
(43) Pub. Date: Nov. 18, 2004

(54) Decorative blown glass and the method of its production

(76) Inventor: Dana Aylor, Glendale, NY (US)

Correspondence Address: Dykema Gossett, PLLC, Suite 300 West, 1300 I Street, N.W., Washington, DC, 20005-3306, US

(21) Appl. No.: 10/767,337

(22) Filed: Jan. 30, 2004

(30) Foreign Application Priority Data
Feb. 28, 2003 (CZ) PV 2003-602

(51) Int. Cl. C03B 9/00

(52) U.S. Cl. 428/210; 65/29.19; 65/29.21; 65/46

(57) ABSTRACT

A blown body or slice from differently colored or saturated millefiori glass of a given design of 5 to 30 times enlarged over the entire area while maintaining its proportionality is sealed inside a basic transparent glass 0.5 to 3 mm thick, and pre-heated so that during its attachment to a hot glass bottle made of basic transparent glass the viscosity of its contact surface is in the range of 10⁴ to 10⁹ Pas, whereafter, the bottle is shaped by enlarging the millefiori design while maintaining the proportionality of its design. The blank glass bottle with the millefiori is overlaid by basic glass, shaped further by heating, rolling and blowing it into a final shape and into the enlarged millefiori design while maintaining the proportionality of its design and while obtaining the final thickness of glass of the product of 0.5-3 mm in the area of the sealed millefiori.

### RELATED APPLICATIONS

This application claims benefit of priority of Czech Republic Application Serial No. PV 2003-602, filed Feb. 28, 2003.

### BACKGROUND OF INVENTION

a. Field of Invention

The invention relates generally to decorative blown glass, and, more particularly to beverage glass, made from conventional transparent glass, decorated by a glass body or a slice of millefiori glass of a given design, color or saturation different from that of the conventional transparent glass. The invention further relates to the production method of decorative blown glass, especially beverage glass, decorated by a decorative glass body or a slice of millefiori glass of a given design, color or saturation different from that of the conventional transparent glass.

b. Description of Related Art

The decoration of glass using the millefiori technique, which typically employs decorative bodies also called millefiori, is well-known in the art. The decoration method first requires the preparation of all the decorative body (i.e. the millefiori, made from various-colored, generally multicolored glasses). The preparation is further carried out by placing colored glass rods next to each other in a metal cast in order to combine with the hot glass which is subsequently overlaid. The colored bunch that is obtained is stretched into glass rods of a predetermined thickness, typically averaging 2 to 10 mm, and thereafter cooled down. The cooled rod is cut into thin circular slices, typically 3 to 5 mm thick, which include multicolored spots in the cross-section, thus creating an impression of flowers or other motifs, which has given the aforementioned production method and decorative glass the name millefiori—a thousand flowers. If needed, thin circular slices can also be lightly melted on the surface for small decorative bodies, usually in the shape of a grain or a pip, with a requirement of maintaining the multicolored design of the millefiori.

The millefiori decoration technique is a known method for the glasswork production of thick-walled glass. The decorative millefiori body is stuck on the surface of a hot glass core, which can be overlaid by new glass if necessary and finished in the desired final product form. Thus it is possible to obtain a glass paperweight, thick-walled vase, jug and other such objects. The final product can also be consistently processed by stretching crystal glass and blowing or rolling. At the same time the color pattern either remains the same or increases 2 to 3 times in size. In this manner, decorative glass is obtained, which is decorated by multicolored decorative millefiori, sealed in either a practically unchanged form on the surface or inside transparent glass, or sealed inside the thick-walled transparent glass during the slight enlargement that occurs when shaping the basic transparent glass into the desired shape by blowing.

For thin-walled products however, the proportionality of the design can become non-uniform when blowing the basic glass with the millefiori glass due to the uneven viscous flow, which results in loss of the finished product's aesthetic value. Accordingly, the aforementioned technique is not used for the production of thin-walled glass. The availability of a technique for production of thin-walled glass would however be economically invaluable since millefiori is produced from various types of colored glass, often containing extractible heavy metals and these would be safely sealed between two layers of transparent glass, usually crystal.

Accordingly, a goal of the present invention is the application of the millefiori decorative technique to thin-walled glass, especially for beverage glasses.

Based upon the aforementioned factors and concerns, there remains a need for decorative blown glass and the method of its production employing the millefiori decorative technique to thin-walled glass in an efficient, economical, and reliable manner.

### SUMMARY OF INVENTION

The invention solves the problems and overcomes the drawbacks and deficiencies of prior art glass production techniques by providing a novel decorative blown glass and the method of its production.

Generally, for the present invention, millefiori glass that has been preheated in advance is attached to a hot glass bottle made from basic transparent glass, following which the bottle with the millefiori is heated up, rolled, and shaped by blowing. The resulting blank bottle with the millefiori is overlaid by another layer of basic transparent glass. Once more, the bottle is heated up, rolled and blown to the desired final shape manually or in a form and thereafter cooled down.

The aforementioned process which enables the acquisition of decorative blown thin-walled beverage glass using the millefiori technique is the subject of the present invention. The process may consist of a blown body or slice made of distinctly colored or saturated millefiori glass of a given design, enlarged 5 to 30 times while maintaining its proportionality, being sealed inside basic transparent glass 0.5 to 3 mm thick.

The invention thus provides decorated glass produced by first pre-heating a decorative glass body or slice of millefiori glass with a given design so that when stuck to a hot glass bottle made of basic transparent glass, the viscosity of its contact surface being in a range of 10⁴ to 10⁹ Pas. After attachment of the millefiori, the bottle may be shaped by first being heated, then rolled up, blown, and the millefiori design being concurrently enlarged while maintaining the proportionality of its design. The blank glass bottle with the millefiori acquired may be overlaid by basic glass, heated up, rolled and blown into the final shape of the product and into the millefiori design, sealed inside the basic transparent glass, and finally enlarged from 5 to 30 times while maintaining the proportionality of its design and while attaining the final thickness of the glass of the product of 0.5 to 3 mm in the area of the sealed millefiori.

Thus exemplary advantages of the present invention include obtaining a new original decorative thin-walled product, decorated with a color motif created by enlarging the basic millefiori color design, sealed between two transparent ecologically-harmless layers of glass.

The invention achieves the aforementioned exemplary advantages by providing decorative blown glass produced from basic transparent glass decorated by a glass body or a slice of millefiori glass of a given design and a color or saturation different from the basic transparent glass. The blown glass may include a blown body or slice from differently colored or saturated millefiori glass of a given design being enlarged at least two times while generally maintaining its proportionality and being sealed inside the basic transparent glass.

For the blown glass described above, the design may be enlarged at least five to thirty times. The basis transparent glass may have a thickness of about 0.5 to 3 mm. The decorative blown glass may be a beverage glass. The transparent glass may be crystal.

The invention also provides a method of production of the decorative blown glass, the blown glass being decorated by a glass decorative body or slice of millefiori glass of a given design of a color or saturation different from basic transparent glass, during which millefiori glass, preheated in advance, is attached to a hot glass bottle made from the basic transparent glass, following which the bottle with the millefiori is heated, rolled and shaped by blowing, thereby defining a blank bottle, the blank bottle with the millefiori is overlaid by a further layer of basic transparent glass, once again the bottle is heated up, rolled and blown to a desired final shape manually or in a form and then cooled down. The method may include heating the decorative glass body or slice of millefiori glass with a given design in advance so that during its attachment to the hot glass bottle made of basic transparent glass, a viscosity of its contact surface is in a range of about 10⁴ to 10⁹ Pas, after being attached, the millefiori with the bottle is shaped by heating, rolling and blowing while concurrently enlarging the millefiori design while maintaining the proportionality of its design, and interstratifying the blank of the glass bottle with the millefiori obtained by the basic glass being heated, rolled and blown to a final shape and into the millefiori design, sealed inside the basic transparent glass, and enlarged at least two times while maintaining the proportionality of its design.

For the method described above, the design may be enlarged at least five to thirty times. The basis transparent glass may have a thickness of about 0.5 to 3 mm in the area of the sealed millefiori. The decorative blown glass may be a beverage glass. The transparent glass may be crystal. The desired viscosity of the basic transparent glass of the bottle before attaching the millefiori may be determined by measuring the temperature with a radiation pyrometer in the spectrum of infrared waves longer than 5 μm.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an isometric view of blown decorative beverage glasses according to the present invention; and

FIG. 2 is a front view of another blown decorative beverage glass according to the present invention.

### DETAILED DESCRIPTION OF THE PREFERRED EMBODIMENTS

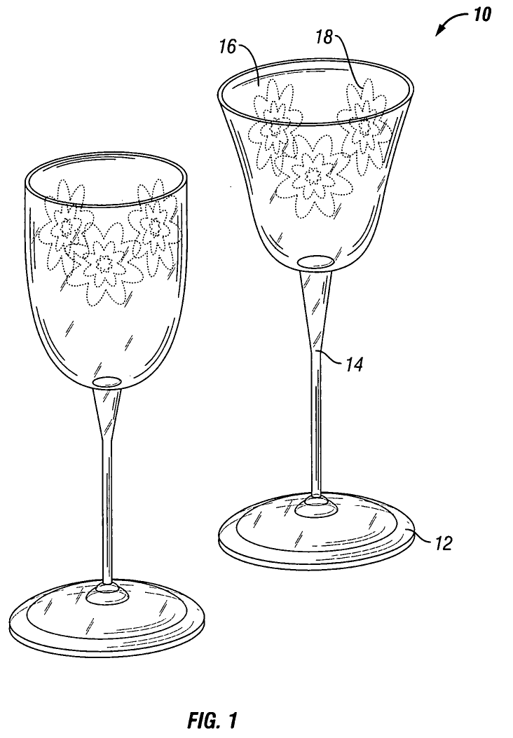

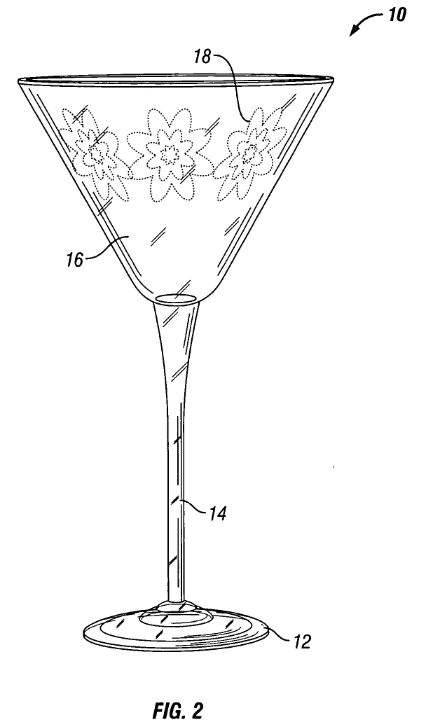

Referring now to the drawings wherein like reference numerals designate corresponding parts throughout the several views, FIGS. 1-2 illustrate exemplary views of blown decorative beverage glasses according to the present invention, generally designated “decorative glass 10.”

Referring to FIGS. 1-2, a first embodiment of decorative glass 10 in the form of a beverage glass may include a bottom 12, stem 14 and thin-walled “onion-shaped” bowl 16 with roughly 2 mm thick walls, and may be produced from transparent barium crystal glass. In the example shown in FIG. 1, five glass millefiori bodies (not shown) or decorations 18, each created from four various colored glasses (in the shape of a heart, for example), may be sealed inside thin-walled bowl 16. Each original millefiori glass slice may have an average diameter of 6 mm and an average thickness of 2 mm. Each millefiori decoration 18 blown and sealed inside bowl 16 of decorative glass 10 maintains its proportionality of decoration 18 on the surface of approximately 40 to 60 mm on average, which is roughly 6 to 10 times larger than the original millefiori slice. In this manner, a unique beverage glass may be obtained, made of clear glass with a thin-walled bowl inside with five or more expressively-colored and enlarged millefiori bodies 18 in the shape of a heart sealed therein. At the same time, the surface of thin-walled bowl 16 with the sealed decoration inside remains smooth on the inside and outside and is created solely from crystal glass. Thin-walled bowl 16 is decorated by blowing and by enlarging the decoration across the entire surface, even partly on the bottom of the bowl. The decoration may be discontinued at the open end of bowl 16 because of the edge being sufficiently cut during manual production.

The temperature of the millefiori design before attachment is of importance when obtaining the type of decorations discussed herein. Measuring this temperature using a radiation pyrometer can be difficult since the dimensions of the millefiori are smaller than the field of view of the pyrometer. Thus a method of preheating the millefiori in a pilot furnace at a constant temperature, measured by a thermoelement and regulated, is preferable.

For products of unique and difficult shapes, millefiori glass with a viscosity that is higher than the basic glass at the given temperature is preferable. For automating the production, the millefiori blank may be heated in a pilot furnace with a regulated temperature and the temperature of the bottle may be measured by a radiation pyrometer right before attaching the millefiori. When applying various types of millefiori to one bottle, the basic bottle may be cooled off or heated up selectively for attaining various temperatures of the perfect contact when applying.

At the same time the temperature of the contact surface should not drop below the transformation temperature of both glasses in order to prevent fractures in the glass. Another condition consists of harmonizing the coefficient of the thermal expansion of the basic glass and the millefiori glass, for which the difference should not be higher than 0.3·10⁻⁶ K⁻¹.

After gathering and creation of the basic bottle, it is necessary to attach a small slice or pip of millefiori glass with a color design on its surface. In order for the two various glass elements to be connected, their surfaces must have such a temperature so that when they are brought into close contact, the resulting temperature of the contact surface is higher than or the same as the so-called binding temperature which corresponds to the viscosity of the softer glass of approximately 10⁹ Pas. The resulting temperature of the contact surface, on the condition of a true perfect contact, is given by the initial temperatures of both surfaces of the connecting parts and their characteristics, which in the present case would be the coefficient of heat penetration of both glasses.

This ratio may be expressed as:

$$\frac{{t}_{b} - {t}_{s}}{{t}_{s} - {t}_{m}} = \frac{{E}_{m}}{{E}_{b}} \qquad Equation ( 1 )$$

where:

t_{b} is the initial temperature of the surface of the parison of the glass blank (° C.),

tₘ is the initial temperature of the surface of the millefiori slice (° C.),

tₛ is the resulting temperature of the mutual surface in the instant of the perfect contact (° C.),

E_{b} is the coefficient of heat penetration of the glass making up the bottle (J.m².s^{-1/2}), and Em is the coefficient of heat penetration of the glass making up the millefiori (J.m².s^{-1/2}).

The coefficient of heat penetration of each glass is given by the equation

E=\sqrt{λρcₚ} Equation (2)

where:

x is the thermal conductivity of the glass (W.m⁻¹.K⁻¹),

ρ is the specific density of the glass (kg.m⁻³), and

cₚ is the specific heat of the glass (J.kg⁻¹K⁻¹).

Because the specific density and specific heat do not differ much for glass of the same type, the rate of their coefficient of heat penetration is largely determined by the rate of their thermal conductivity. The conductivity of a basic bottle from crystal glass is high. If the so-called effective thermal conductivity is expressed, which includes the transfer of heat by true thermal conductivity as well as by radiation, the following ratio results, thanks to the small capacity of the thermal radiation for the colored or opal glass which makes up the millefiori design:

$$\frac{{E}_{m}}{{E}_{b}} \approx \sqrt{0.5} - \sqrt{0.25} = 0.7 - 0.5 \qquad Equation ( 3 )$$

If the influence of the temperature on thermal conductivity is taken into account, which is considerable for glass with a marked share of heat transfer by heat radiation, a low rate of thermal capacity can be reached:

E_{b}/Eₘ₌0.3.

It is then possible to calculate the temperature of the contact surface from Equation (1), to ascertain the respective viscosity from the viscosity curve of the softer glass and to decide whether or not attachment has occurred (i.e. if this viscosity is lower than 10⁹).

A further limitation is that the resulting temperature of the contact surface cannot be lower than the transformation temperature of the basic form. If such is the case, then further lowering of the temperature results in the occurrence of internal tensile stress, which causes a fracture to arise. While this may be closed up with further heating, the geometry of the design remains impaired because, during the production of thin-walled glass, the thermal capacity in the wall is small and cooling down occurs quickly.

Thus another gathering must result quickly after attaching the millefiori design in such a case. If however, the heating of the millefiori design occurs too rapidly and its temperature is below the transformation temperature of the glass, pressure stress arises in the colored glass, which also leads to destruction of the design. The blank of the millefiori design may be created by sticking rods of various glasses with various expansibilities together, so there is stress in the blank itself. If the temperature of the millefiori blank is low, meaning it has a viscosity higher than or the same as the surface of the cooled-down bottle, then this high viscosity prevents blowing of the design, which is only slightly enlarged and only stretches out in the nearest vicinity. If the temperature of the surface design before being received is too high, the design is stretched out greatly while blowing, during which it often loses proportion and the design is damaged.

The temperature required for Equation (1) is determined by an expedient measurement using a radiation pyrometer in the spectrum of infrared waves longer than 5 μm. For difficultly-shapeable products, it is advantageous to choose a millefiori blank with a viscosity higher than the basic glass at the given temperature so that the proportionality of the decoration is not impaired. For production automation, it is advantageous when the millefiori blank is heated in the pilot furnace with a regulated temperature for the even heating of the glass and the temperature of the bottle to be measured by a pyrometer right before the attachment itself. When applying millefiori with various characteristics to one bottle, the basic bottle is cooled down or heated up selectively for attaining the various temperatures of the perfect contact.

The desired temperature may be calculated according to Equation (1). The basic glass is transparent barium crystal with an expansibility of 8.5.10⁻⁶ K⁻¹ and the effective thermal conductivity is 120 W.m⁻¹. K⁻¹ at a temperature of 1000° C. A circular plate averaging 6 mm wide and 2 mm high, made up of four various-colored glasses, is used as the millefiori design. The design created, a heart for example, is not axially symmetrical. The expansibility of the glass used (opal, orange, ruby, cobalt blue, turquoise, etc.) differs from the basic glass by ±0.3.10⁻⁶ K⁻¹, which guarantees the occurrence of only safe internal stress. The effective thermal conductivity of these glasses varies widely, of course, it is always significantly lower than basic crystal and therefore opal glass, which forms the basis of the glass colors used (approximately 30 W.m⁻¹.K⁻¹ at 1000° C. and 8 W.m⁻¹.K⁻¹ at 500° C.), is chosen for the calculation of conductivity. The basic bottle is gathered in a furnace with a temperature of 1100° C., after blowing and rolling with a damp roller the external surface of the bottle, relatively thin-walled, has a temperature of 850° C., which may be ascertained by a Minolta-L and radiation pyrometer, which works in the spectral frequency of 8-12 μm where the glass is impenetrable, so the pyrometer's information corresponds to the temperature of the layers at a surface 0.2 mm thick, at most. The emissivity may be set at a value of 0.85, which corresponds to the emissivity of the measured glass in this spectral frequency. Only values measured in this manner correspond to the actual temperature of the bottle's surface.

By a calculation in accordance with Equation (1), the temperature of the contact surface when preheating the millefiori design to 300° C. amounts to a range of 667-730° C., which is a value sufficient for the attachment, but the viscosity is low, and after taking and blowing it, a great enlargement of the design would take place, impairing the proportionality. It is therefore important to roll the parison longer so that the temperature of the surface decreases, to choose a lower initial temperature of the millefiori plate or other millefiori design, which has a thermal conductivity closer to the basic crystal glass.

If ionic colored glass that does not have a dispersing center (colored, for example, by cobalt, copper, etc.) is used, one can count on a coefficient of heat penetration ratio of crystal and millefiori of 0.8 which leads to a temperature of 605° C. for the contact surface of both glasses during a perfect contact.

Longer rolling leads to a surface temperature of 750° C. when the bottle already has a viscosity of 10⁵-10⁶ Pas and is predominately solid. The surface temperature during perfect contact is calculated to be 600° C. for opal millefiori and 550° C. when ionic-colored. The first temperature may satisfy the requirements for attaching and for blowing, the second is even better for blowing as it is closer to the transformation temperature of 480-500° C. for the glass used.

The third possibility may be to lower the temperature for preheating the millefiori plate. If one chooses a temperature of 200° C. and rolls to 750° C., the temperature of perfect contact of ionic-colored millefiori would be 472° C. and 533° C. for opal glass. This value satisfies the requirements for opal glass but is below the transformation temperature for ionic-colored millefiori. The example shown thus documents the importance of determining the initial temperature and characteristics of the glass.

It is advantageous to preheat the millefiori in a regulated furnace and to measure the temperature of the bottle with a pyrometer. The method of production in accordance with this invention enables the entire production to be automated.

For the second embodiment of the present invention, a glass goblet of the “champagne—flute” type (not shown) characterized by a truncated narrow shape slightly widening towards the top is made from clear crystal. Five glass millefiori bodies may be sealed inside the thin-walled bowl of the champagne—flute type. Each body may represent a different original millefiori design, expressively colored, and made from at least four differently colored glasses. All of the millefiori designs may represent a fanciful shape of an open flower, however. The pips of millefiori glass may on average be 3 mm in diameter and 2 mm thick. The millefiori flower decoration, blown and sealed inside the bowl of a beverage glass of the champagne—flute type, maintains its proportionality of the flower design on the surface of approximately 40 to 50 mm on average, which is roughly 13 to 17 times larger than the original millefiori pip. In this manner, an interesting beverage glass is obtained, made of clear glass with a thin-walled bowl of the champagne—flute type inside which expressively-colored and enlarged millefiori flower designs are sealed, visually across the entire surface of the bowl. At the same time the inside and outside surface of the wall of the bowl is smooth, shiny and made of crystal glass.

The fact that there is a relatively thick layer of “ice” glass (1 to 2 cm) at the stem must be taken into consideration during the production of this product.

A goblet of the type of “champagne—flute” is produced, characterized by a truncated narrow shape slightly widening towards the top. At the stem there is a relatively thick (1-2 cm) layer of “ice” glass, which causes a large heat capacity at the stem, while the body of the bowl, on the other hand, is very weak-walled (1 to 1.5 mm thick). This also means it is quite difficult to maintain the proportions of the millefiori design when blowing. The design not only unilaterally expands, but its rotation and the blurring of the contours also occurs because a large temperature gradient occurs along the bowl. This can be prevented in part by a suitable choice of the initial shape during the preparation of the blank as well as by the choice of a harder glass for its production, and in part directly in the glassworks using a suitable temperature for the bottle before taking it. That must be low enough so that the design only expands during the rolling (i.e. evenly) and not at all when blowing, when it expands in one direction. It is important to choose the lowest temperature possible for preheating the design and more advantageous to choose an opal adiathermanous millefiori. The temperature of the perfect contact may be chosen to be as close as possible to the binding temperature, in other words the lowest possible temperature.

The examples of the application mentioned are not exhausted and other variations in the methods of production of decorative glass are possible according to this invention in the framework of the range of the ideas of the patented claims.

It is possible to apply the above in the automated production of beverage glass where it is possible to expect high demands, however, on the maintenance of technology and a restriction on the assortment of original designs.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A decorative blown glass produced from basic thin-walled transparent glass decorated by a glass body or a slice of millefiori glass of a given design and a color or saturation different from said basic thin-walled transparent glass, said blown glass comprising:
a blown body or slice from differently colored or saturated millefiori glass of a given design being enlarged at least two times while generally maintaining its proportionality and being sealed inside said basic transparent glass.

2. A decorative blown glass according to claim 1, wherein said design being enlarged at least five to thirty times.

3. A decorative blown glass according to claim 1, wherein said basis transparent glass has a thickness of about 0.5 to 3 mm.

4. A decorative blown glass according to claim 1, wherein said decorative blown glass is beverage glass.

5. A decorative blown glass according to claim 1, wherein said transparent glass is crystal.

6. A method of production of the decorative blown glass, said blown glass being decorated by a glass decorative body or slice of millefiori glass of a given design of a color or saturation different from basic transparent glass, during which millefiori glass, preheated in advance, is attached to a hot glass bottle made from the basic transparent glass, following which the bottle with the millefiori is heated, rolled and shaped by blowing, thereby defining a blank bottle, the blank bottle with the millefiori is overlaid by a further layer of basic transparent glass, once again the bottle is heated up, rolled and blown to a desired final shape manually or in a form and then cooled down, said method comprising:
heating the decorative glass body or slice of millefiori glass with a given design in advance so that during its attachment to the hot glass bottle made of basic transparent glass, a viscosity of its contact surface is in a range of about 10⁴ to 10⁹ Pas;
after being attached, the millefiori with the bottle is shaped by heating, rolling and blowing while concurrently enlarging the millefiori design while maintaining the proportionality of its design; and
interstratifying the blank of the glass bottle with the millefiori obtained by the basic glass being heated, rolled and blown to a final shape and into the millefiori design, sealed inside the basic transparent glass, and enlarged at least two times while maintaining the proportionality of its design.

7. A method according to claim 6, wherein said design being enlarged at least five to thirty times.

8. A method according to claim 6, wherein said basis transparent glass has a thickness of about 0.5 to 3 mm in the area of the sealed millefiori.

9. A method according to claim 6, wherein said decorative blown glass is beverage glass.

10. A method according to claim 6, wherein said transparent glass is crystal.

11. A method according to claim 6, wherein the desired viscosity of the basic transparent glass of the bottle before attaching the millefiori is determined by measuring the temperature with a radiation pyrometer in the spectrum of infrared waves longer than 5 μm.
